(19) United States
(12) Patent Application Publication
(10) Pub. No.: US 2020/0334265 A1
(43) Pub. Date: Oct. 22, 2020

(54) COMPUTER PROGRAM FOR PROVIDING SPACE MANAGEMENT FOR DATA STORAGE IN A DATABASE MANAGEMENT SYSTEM

(71) Applicant: TmaxData Co.,Ltd., Seongnam-si (KR)

(72) Inventors: Sang Young PARK, Seoul (KR); Tai Kyoung KIM, Seongnam-si (KR); Hakyong LEE, Seongnam-si (KR); Chanho HWANG, Yongin-si (KR); Minho LEE, Yongin-si (KR); Wooseok CHOI, Yongin-si (KR)

(21) Appl. No.: 16/426,134

(22) Filed: May 30, 2019

(30) Foreign Application Priority Data
Apr. 17, 2019 (KR) 10-2019-0044646

(51) Int. Cl. G06F 16/25; G06F 16/21; G06F 16/2457; G06F 16/22; G06F 12/0802

(52) U.S. Cl. CPC G06F 16/254; G06F 16/21; G06F 12/0802; G06F 16/2282; G06F 16/24573

(57) ABSTRACT

Disclosed is a non-transitory computer readable medium including a computer program. The computer program causes a computer to perform steps for performing space management for data storing of a database management system (DBMS) when executed by one or more processors.

### CROSS-REFERENCE TO RELATED APPLICATIONS

This application claims priority to and the benefit of Korean Patent Application No. 10-2019-0044646 filed in the Korean Intellectual Property Office on Apr. 17, 2019, the entire contents of which are incorporated herein by reference.

### TECHNICAL FIELD

The present invention relates to a database management system (DBMS) and, more particularly, space management in a database management system.

### BACKGROUND ART

A database means a set of standard data that is integrally managed to be shared and used by several people. In general, data related to specific departments of an organization is collected and the data may be used to provide information for supporting decision-making at several levels.

Recently, as the amount of data becomes increasingly massive, utilization of a database management system (hereafter, DBMS) that efficiently supports searching for data from a database or changing (inserting, correcting, deleting, and updating) data is increased.

A DBMS can store all data in the format of table in a database. A table is a fundamental structure for storing data in a database and one table is composed of one or more records. When a specific query is input from the outside, a DBMS performs functions such as selecting, inserting, deleting, and updating data in a database. The query, which means description of a requirement about data stored in tables in a database, that is, what operation is wanted to be performed on data, can be expressed through a language such as a Structured Query Language (SQL).

The DBMS stores records in the format of table on a disk and updates the records in correspondence to queries from the outside (a client or another application). Records are deleted, inserted, or changed in size in this process, so the location and size of empty spaces (free spaces) are continuously changed. Accordingly, it is important to identify the location and size of free spaces that are changed in real time in order to efficiently provide spaces in correspondence to sessions for a space request.

In general, in order to identify the location and size of a free space of a DBMS and quickly provide a space, some hint data is given on a memory, and when there is a space request, a data block corresponding to the request is provided with reference to the hint data.

However, DBMSs of the related art have a tree architecture having several data files mapped to one table and the hint data architecture for managing the tree architecture also has a very complicated format. Accordingly, there is complexity in that it is required to search a corresponding block every time when referring to a hint data architecture in order to identify the location and size of a free space and provide a space.

Therefore, there may be, in this field, a demand for a computer program that can improve speed of searching for and accessing a free space to efficiently manage spaces for storing data in a database management system.

### DOCUMENTS OF RELATED ART

(Patent Document 1) U.S. Pat. No. 7,188,113

(Patent Document 2) KR10790991

### SUMMARY OF THE INVENTION

The present invention has been made in an effort to provide a computer program that provides space management for storing data in a database management system.

An exemplary embodiment of the present invention for solving the above-mentioned problems, provides a non-transitory computer readable medium including a computer program. The computer program causing a computer to perform steps for performing space management for data storing of a database management system (DBMS) when executed by one or more processors, the steps including: maintaining one or more meta files for respectively managing spaces of one or more data files included in a data file group, in a persistent storage, wherein the data file includes one or more data blocks, the meta file includes one or more meta blocks, and the meta block includes meta information for managing the spaces of the one or more data blocks; creating a space management structure including available space level unit and Data Block Address (DBA) of at least some of the data blocks managed by the meta blocks based on the meta information included in the meta blocks of the meta files, and maintaining the created space management structure on a memory, wherein the DBA presents address information of the data block and the available space level unit is predetermined to quantitatively present the size of an available space in the data block; and determining the data blocks to be assigned corresponding to a space request for the data file group, by referring to the space management structure maintained on the memory, in response to the space request.

Alternatively, the number of meta blocks for managing the space of at least a portion of the data file is determined based on size information of the data files.

Alternatively, the data file group is mapped to one object, the space management structure corresponds to one data file group, and the object means a logical storage architecture existing in a database and includes at least one of a table and an index.

Alternatively, each of the one or more data blocks includes fourth information presenting the size of an available space to which a change of the available space by uncommitted transaction has not been reflected.

Alternatively, each of the one or more data blocks includes sixth information, which is information about a space variation changed by a data change, when data stored in a data block is changed by a transaction, and the steps further include updating fourth information based on the sixth information when the transaction is committed.

Alternatively, the meta information includes second information presenting the available space level unit of each of one or more data blocks that are managed by the meta blocks, and the available space level unit is based on fourth information presenting the size of an available space to which a change of the available space by uncommitted transaction has not been reflected.

Alternatively, the steps further include: identifying a commit of a change of data stored in the one or more data blocks; when the commit of the change of data stored in the one or more data blocks is identified, identifying whether an available space level unit, corresponding to fourth information of the data block that the commit of the change of data is identified, is changed; and updating the meta information of the meta block managing the data block when the change of the available space level unit corresponding to the fourth information is identified.

Alternatively, each of the one or more data blocks includes fifth information presenting the size of an actually usable available space to which a change of the available space by uncommitted transaction has been reflected.

Alternatively, the meta information includes second information presenting the available space level unit of each of one or more data blocks that are managed by the meta blocks, and the available space level unit is based on fifth information presenting the size of the available spaces of the data blocks.

Alternatively, the steps further include: identifying a change of data stored in the one or more data blocks; when the change of data stored in the one or more data blocks is identified, identifying whether an available space level unit, corresponding to fifth information of the data block that the change of data is identified, is changed; and when a change of the available space level unit corresponding to the fifth information is identified, updating the meta information of the meta blocks managing the data block.

Alternatively, the meta information includes at least one of: first information presenting the range of one or more data blocks managed by the meta blocks; or third information presenting the number of data blocks corresponding to the available space level unit.

Alternatively, the creating a space management structure including available space level unit and Data Block Address (DBA) of at least some of the data blocks managed by the meta blocks based on the meta information included in the meta blocks of the meta files, and maintaining the created space management structure on a memory includes: recording a first mark to the meta blocks managing the space of the data blocks corresponding to the DBAs to prevent the data blocks from being included in the space management structure in duplicate; and the steps further include: receiving work completion information that is information about work completion on a data block assigned corresponding to the space request; and when the work completion information is received, removing the first mark for the data block from the meta block managing the space of the data block that work is completed.

Alternatively, creating a space management structure including the DBA and available space level unit of at least some of data blocks managed by the meta blocks based on the meta information included in the meta blocks of the meta file and maintains the created space management structure on the memory, includes: additionally assigning the DBA of at least one data block to the space management structure based on the meta information of the one or more meta files corresponding to the space management structure, when it is identified that the number of the DBAs of the data block included in the space management structure is equal to or less than the number of the DBAs of predetermined data blocks.

Alternatively, additionally assigning the DBA of at least one data block to the space management structure based on the meta information of the one or more meta files corresponding to the space management structure, when it is identified that the number of the DBAs of the data block included in the space management structure is equal to or less than the number of the DBAs of predetermined data blocks includes: identifying HWM of a data file mapped to the space management structure, when the DBA of a data block to be additionally assigned to the space management structure does not exist in the meta information of the meta file corresponding to the space management structure; creating a first HWM by updating the identified HWM; and assigning the DBA of an additional data block to the space management structure based on the meta blocks managing the space of the data blocks between the HWM and the first HWM.

Alternatively, the space request includes at least one of: minimum available space information for each of one or more data blocks; minimum available space information for the sum of the available spaces of the one or more data blocks; or information about the number of data blocks.

Alternatively, determining the data blocks to be assigned corresponding to a space request for the data file group, by referring to the space management structure maintained on the memory, in response to the space request, includes: removing the DBA of at least one returned data block from the space management structure, when at least one data block is returned corresponding to the space request.

Alternatively, determining the data blocks to be assigned corresponding to a space request for the data file group, by referring to the space management structure maintained on the memory, in response to the space request includes: identifying the number and size of data blocks to be returned corresponding to the space request for the data file; and selecting data blocks to be returned corresponding to the identified number and size of data block by referring to the space management structure.

Alternatively, determining the data blocks to be assigned corresponding to a space request for the data file group, by referring to the space management structure maintained on the memory, in response to the space request includes: identifying the size of available space of a data block to be returned in response to the space request for the data file group; and identifying the available space level unit included in the space management structure corresponding to the size of the identified available space, and selecting the DBA of one or more data blocks matched with the identified available space level unit.

Another exemplary embodiment provides a database server for performing space management for data storing of a database management system. The database server includes: a processor including one or more cores; a memory storing program codes that can be executed by the processor; and a network unit transmitting/receiving data to/from a client, wherein the processor: maintains one or more meta files for respectively managing spaces of one or more data files included in a data file group, in a persistent storage, wherein the data file includes one or more data blocks, the meta file includes one or more meta blocks, and the meta block includes meta information for managing the spaces of the one or more data blocks; creates a space management structure including available space level unit and Data Block Address (DBA) of at least some of the data blocks managed by the meta blocks based on the meta information included in the meta blocks of the meta files, and maintains the created space management structure on a memory, wherein the DBA presents address information of the data block and the available space level unit is predetermined to quantitatively present the size of an available space in the data block; and determines the data blocks to be assigned corresponding to a space request for the data file group, by referring to the space management structure maintained on the memory, in response to the space request.

Yet another exemplary embodiment provides a method for performing space management for data storing of a database management system. The method comprising: maintaining one or more meta files for respectively managing spaces of one or more data files included in a data file group, in a persistent storage, wherein the data file includes one or more data blocks, the meta file includes one or more meta blocks, and the meta block includes meta information for managing the spaces of the one or more data blocks; creating a space management structure including available space level unit and Data Block Address (DBA) of at least some of the data blocks managed by the meta blocks based on the meta information included in the meta blocks of the meta files, and maintaining the created space management structure on a memory, wherein the DBA presents address information of the data block and the available space level unit is predetermined to quantitatively present the size of an available space in the data block; and determining the data blocks to be assigned corresponding to a space request for the data file group, by referring to the space management structure maintained on the memory, in response to the space request.

The present invention may provide a computer program providing space management for data storing in a database management system.

### BRIEF DESCRIPTION OF THE DRAWINGS

Various aspects are described with reference to drawings, in which like reference numerals are generally used to indicate like components. In the following embodiments, a plurality of specific specifications is proposed for general understanding of one or more aspects. However, it would be apparent that the aspect(s) can be achieved without those specifications.

FIG. 1 is a schematic view of a database system according to an embodiment of the present invention.

FIG. 2 is a block diagram presenting the configuration of a database server according to an embodiment of the present invention.

FIG. 3 is a diagram schematically presenting the detailed configuration of a meta file according to an embodiment of the present invention.

FIG. 4 is a diagram schematically presenting a space management structure according to an embodiment of the present invention.

FIG. 5 is a flowchart for providing space management for storing data in a database management system according to an embodiment of the present invention.

FIG. 6 is a flowchart exemplifying a space management method for storing data in a database management system according to an embodiment of the present invention.

FIG. 7 is a flowchart exemplifying a space management method for storing data in a database management system according to an embodiment of the present invention.

FIG. 8 illustrates means for space management for storing data in a database management system related to an embodiment of the present invention.

FIG. 9 is a brief and general schematic diagram of an exemplary computing environment in which an embodiment of the present invention can be implemented.

### DETAILED DESCRIPTION

Various embodiments will be described hereafter with reference to drawings. A description is proposed herein in various ways to help understand the present invention. However, it is apparent that the embodiments may be performed even without such a detailed description.

Terms “component”, “module”, “system”, etc. used herein denote computer-related entity, hardware, firmware, software, a combination of software and hardware, or execution of software. For example, a component may be a procedure that is executed on a processor, a processor, an object, an execution thread, a program, and/or a computer, but is not limited thereto. For example, applications that are executed in a computing device and the computing device both may be components. One or more components may reside in a processor and/or an execution thread. One component may be localized in one computer. One component may be distributed between two or more computers. Further, these components may be executed through various computer-readable media having various data architectures stored therein. Components can perform communication through local and/or remote processes, for example, in accordance with signals having one or more data packets (e.g., data from one component interacting with another component in a local system or a distribution system, and/or data transmitted through a network such as another system and the internet by signals).

The term “or” is intended to mean not exclusive “or”, but comprehensive “or”. That is, unless specified otherwise or being clear in the sentence, “X uses A or B” is intended to mean one of natural comprehensive substitution. That is, when X uses A; X uses B; or X uses both A and B, “X uses A or B” may be applied to any one of those cases. Further, the term “and/or” used herein should be understood as denoting and including all possible combinations of one or more items of enumerated relevant items.

The term “include” and/or “including” should be understood as meaning that a corresponding characteristic and/or component exists. However, the term “include” and/or “including” should be understood as not excluding existence or addition of one or more other characteristics, components, and/or a group of them. Further, unless specified otherwise or clearly indicating a singular in the sentence, a singular should be generally construed as meaning “one or more” in the specification and claims.

Those skilled in the art should note that various exemplary blocks, configurations, modules, circuits, means, logics, and algorithm steps described in association with the embodiments additionally disclosed herein may be implemented by electronic hardware, computer software, or a combination thereof. In order to clearly exemplify compatibility of hardware and software, various exemplary components, blocks, configurations, means, logics, modules, circuits, and steps were generally described above in terms of their functionality. Whether the functionality is implemented by hardware or software depends on specific applications and design limits that are given to general systems. Skilled engineers may achieve functionalities respectively described in various methods for specific applications. However, the implementation determination should not be construed as departing from the scope of the present invention.

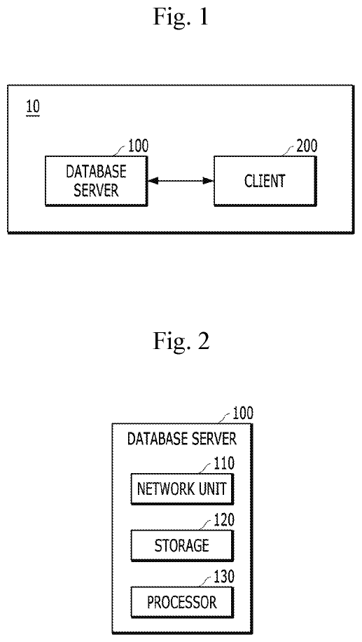

FIG. 1 is a schematic view of a database system according to an embodiment of the present invention.

As shown in FIG. 1, a database system 100 according to the present invention may include a database server 100 and a client 200.

The client 200 may mean any type of node(s) in a system having a mechanism for communication with the database server 100. For example, the client may include a PC, a laptop computer, a workstation, a terminal, and/or any electronic device having network connectivity. Further, the client may include any server that is implemented by at least one of an agent, an Application Programming Interface (API), and a plug-in.

According to an embodiment of the present invention, the operations of the database server 100 to be described below can be performed in accordance with queries issued from the client.

The database server 100, for example, may include any type of computer system or computer device such as a microprocessor, a mainframe computer, a digital single processor, a mobile device, and a device controller. The database server 100, though not shown in FIG. 1, may include a Database Management System (DBMS). Further, the database server 100 may be compatibly used with a device for executing queries.

The DBMS, which is a program for allowing for operations such as parsing queries, and searching for, inserting, correcting, and/or deleting necessary data in the database server 100, may be implemented by a processor 130 in a memory 122 of the database server 100.

The database server 100 may include a device including the processor 130 or a storage 120 for executing and storing instructions as any type of database, but is not limited thereto. That is, the database server 100 may include software, firmware, hardware, or a combination thereof. The software may include an application(s) for creating, deleting, and correcting a database table, a schema, an index, and/or data. The database server 100 may receive transaction from the client or another computing device. The transaction, for example, may include searching for, inserting, correcting, and deleting data, tables, and/or indexes, and/or managing records in the database server 100. Further, although only one database server 100 is shown in FIG. 1, it would be apparent to those skilled in the art that more database servers may also be included in the scope of the present invention and the database server 100 may include additional components. That is, the database server 100 may be composed of a plurality of computing devices. A plurality of sets of nodes may constitute the database server 100.

FIG. 2 is a block diagram presenting the configuration of a database server according to an embodiment of the present invention.

As shown in FIG. 2, the database server 100 may include a network unit 110, a storage 120, and a processor 130. The components described above are exemplified and the right scope of the present invention is not limited to the components. That is, additional components may be included or some of the components described above may be omitted, depending on the implementation aspects of embodiments of the present invention.

According to an embodiment of the present invention, the database server 100 may include the network unit 110 transmitting/receiving data to/from the client 200. Further, the network unit 110 may provide a communication function between the database server 100 and the client 200. The network unit 110 may receive input from the client. For example, the network unit 110 may receive requests related to storing, changing, and inquiring of data, and building, changing, and inquiring of indexes from the client.

A network according to an embodiment of the present invention may use various wired communication systems such as a Public Switched Telephone Network (PSTN), an x Digital Subscriber Line (xDSL), an Rate Adaptive DSL (RADSL), a Multi Rate DSL (MDSL), a Very High Speed DSL (VDSL), a Universal Asymmetric DSL (UADSL), a High Bit Rate DSL (HDSL), and a Local Area Network (LAN).

Further, the network proposed herein may use various wireless communication systems such as a Code Division Multi Access (CDMA), a Time Division Multi Access (TDMA), a Frequency Division Multi Access (FDMA), an Orthogonal Frequency Division Multi Access (OFDMA), a Single Carrier-FDMA (SC-FDMA), and other systems. For example, the network may include a database link (DBlink), so a plurality of database servers may take data from other database servers by communicating with each other through the database link. Technologies described herein are not limited to the networks described above and may be used for other networks.

According to an embodiment of the present invention, the storage 120 may include a persistent storage 121 and a memory 122.

The persistent storage 121 may mean a nonvolatile storage medium that may persistently store any data such as not only a magnetic disc, an optical disc, and a magneto-optical storage device, but a flash memory and/or a storage device based on a battery-backup memory. The persistent storage 121 may communicate with the processor 130 and the memory 122 of the database server 100 through various communication devices. In an additional embodiment, the persistent storage 121 may be disposed outside the database server 100 and may communicate with the database server 100.

The memory may mean a volatile storage device, which is a main storage device that a processor directly accesses and which immediately loses stored data when power is cut, such as a Random Access Memory (RAM) including a Dynamic Random Access Memory (DRAM) and a Static Random Access Memory (SRAM), but is not limited thereto. The memory 122 may be operated by the processor 130. The memory 122 may temporarily store a data table including data values. The data table may include data values, and the data values in the data table may be recorded on the persistent storage 121 from the memory 122 in an embodiment of the present invention. In an additional aspect, the memory 122 includes a buffer cache and data may be stored in data blocks of the buffer cache. The data stored in the buffer cache may be recorded on the persistent storage 121 by a background process.

According to an embodiment of the present invention, the processor 130 may maintain a meta file for managing the spaces of data files including one or more data blocks in a persistent storage. In this case, the processor 130 may determine the number of meta blocks for managing spaces for at least some of the data files (i.e., one or more data blocks) based on the size information of the data files.

A data file group including a plurality of data files may have been mapped to one object. The object means a logical storage architecture existing in a database and may include at least one of a table and an index. Further, the processor 130 may maintain meta information of meta files, which manages spaces of a plurality of data files (i.e., two or more data files) included in the data file group, in a persistent storage.

In this case, a first data file included in the data file group may be matched with a first meta file for managing the space of the first data file and a second data file included in the data file group may be matched with a second meta file for managing the space of the second data file. That is, data files and meta files for managing the spaces of the data files may be one-to-one matched.

In other words, one or more data files and one or more meta files for respectively managing the spaces of the one or more data files may be mapped to one table or one index.

That is, the spaces of one or more data files included in a data file group may be managed by meta files that are matched with the data files one to one, and the data file group may be mapped to one object.

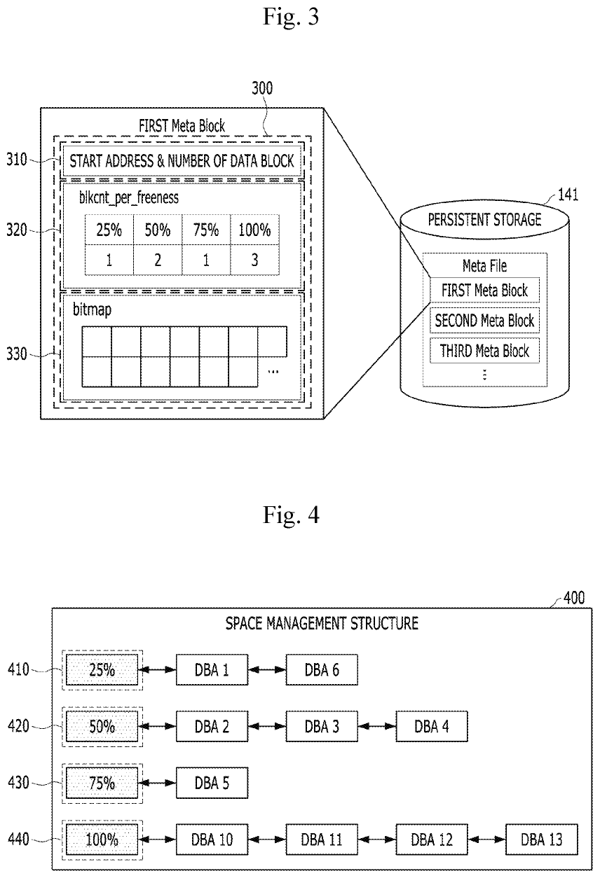

As shown in FIG. 3, a meta file, for example, may include one or more meta blocks (a first meta block, a second meta block, a third meta block, etc.). Further, the meta blocks may include meta information for managing the spaces of one or more data blocks.

The meta information may include at least one item of information of first information 310, second information 330, and third information 320 about information of one or more data blocks that are managed by the meta blocks.

The first information 310 may be information about the range of one or more data blocks that are managed by a meta block. In detail, the first information 310 may include information about a start address (i.e., the Data Block Address (DBA) of the first data block) of one or more data blocks that are managed by a meta block and information about the number of the data blocks. For example, when a first meta block manages a first data block and a second data block, first information of the first meta block may include information presenting that the spaces of two data blocks (i.e., a first data block and a second data block) are managed from the DBA 1 of the first data block. That is, the first information may include information about the spaces of DBA 1 and DBA 2 (i.e., the spaces of the first data block and the second data block) of the first meta file. The detailed description of DBA information and information about the number of the data blocks included in the first data block is only an example and the present invention is not limited thereto.

The second information 330 may be information about the available space of each of one or more data blocks that are managed by a meta block. In more detail, the second information may present available space level units of one or more data blocks that are managed by a meta block. In this case, the available space level units of one or more data blocks may be based on meta information for managing each of the one or more data blocks. For example, the second information 330 may include information presenting that the available space sizes of a first data block and a second data block that are managed by a first meta block are 25% and 50%, respectively. That is, the second information 330 may present the information of the sizes of the available spaces of data blocks managed by a meta block. Further, the second information 330 may present the available space of a data block in a bit map. The above-described detailed numerical values of the size of the available spaces of the first data block and the second data block that are managed by the first meta block are only examples and the present invention is not limited thereto.

The third information 320 may be information about the number of data blocks corresponding to an available space level unit. The available space level unit may be predetermined. For example, the available space level unit, as shown in FIG. 3, may be determined as four units of 100%, 75%, 50%, and 25% and the third information 320 may be information presenting the number of data blocks that are managed by a meta block in correspondence to the four available space level units predetermined. In more detail, for example, as shown in FIG. 3, the total number of data blocks that are managed by the first meta block may be seven and the third information 320 may include information (i.e., 25%-1, 50%-2, 75%-1, and 100%-3) about the number of data blocks respectively matched in correspondence to the available space level units predetermined. The above-described detailed numerical values of the available space level units and the correspondingly matched data blocks are only examples and the present invention is not limited thereto.

A data file may include one or more data blocks and each of the one or more data blocks may include space management information for maintaining consistency with meta information of a meta block. The space management information of each of the one or more data blocks may include at least one item of information of fourth information, fifth information, and sixth information.

The fourth information may be information presenting the size of the available space of a data block until the point in time when a committing occurs. In detail, the fourth information may be information about a space where data may be inserted in each of one or more data blocks and may be the size of an available space to which a change of the available space by a uncommitted transaction (i.e., an active available space) has not been reflected. For example, when the size of the available space of a data block until the point in time when committing occurs is 50% and the currently active space (i.e., before committing) in a corresponding data block is 10%, the fourth information of the data block may include only the information about 50% except for the information presenting that the currently active space of 10% is being used. That is, the fourth information may include information about the available space when a transaction is rolled back without being committed. The above-described detailed numerical value for the size of the available space of the data block is only an example and the present invention is not limited thereto.

The fifth information may be information presenting the size of an available space that may be actually used for a space request. That is, the fifth information may include information about the size of an available space to which a change of the available space by uncommitted transaction has been reflected. In detail, the fifth information may include information about the size of an available space that may be actually used of one or more data blocks and may include information about an available space assigned in correspondence to a current space request (i.e., an active available space). For example, when the fourth information presenting the size of the available space of a data block is 75% and a current active space (i.e., before committing) for inserting data into the data block is 10%, the fifth information of the data block may be information presenting that the actually available space to which the current active space of 10% has been reflected is 65%. The above-described detailed numerical value for the size of the available space of the data block is only an example and the present invention is not limited thereto.

The sixth information may be information about a changed space variation when a data block is assigned in response to a work request. In more detail, the sixth information may be information about a variation of data due to inserting, deleting, and updating of data in a data block. That is, the sixth information may include information about the amount of space usage being used for work in a data block, and for example, may include information about a space occupied by a transaction in a data block.

In detail, for example, when data is deleted from a data block, the sixth information may be information about the size of the increased available space. In detail, when data is decreased by DML for deleting and updating data in a data block, the sixth information may be information about the size of the increased available space. That is, the sixth information may be information that is changed any time during inserting, deleting, and changing of data in a specific data block.

As another example, when data is inserted or deleted in a data block, the sixth information may be information about the size of the decreased or increased available space. In detail, when data is increased by DML for inserting and updating data in a data block, the sixth information may be information about the size of the decreased available space.

The processor 130 may update the fourth information based on the sixth information when work corresponding to a work request is finished. In detail, when the DBA of a data block is returned in correspondence to a work request and work on the data block is finished through the returned DBA of the data block, the processor 130 may update the fourth information through the sixth information that is information about a space variation corresponding to the work (inserting, deleting, updating, etc.).

For example, when the processor 130 returns a data block with an available space of 60% in correspondence to a work request to insert data of 10% into the data block and commits the work by inserting data of 10% into the data block, the processor 130 may update the fourth information by changing the available space from 60% to 50% based on the sixth information that is information of a variation corresponding to reduction of a space of 10% of the data block. The above-described detailed numerical value for the space of the data block is only an example and the present invention is not limited thereto.

That is, the processor 130 may manage the space of a data file including data blocks for storing data by maintaining meta blocks (i.e., a meta file) including meta information in a persistent storage in correspondence to one data file. Further, conformity of the meta blocks may be maintained through the space management information of the data blocks.

According to an embodiment of the present invention, the processor 130 may create a space management structure 400 including available space level units and at least some DBAs of data blocks that are managed by a meta block of a meta file based on meta information included in the meta block, and may maintain the created space management structure 400 on the memory 122. The space management structure 400 may correspond to one data file group (or one object). The DBA may present the address information of a data block and the available space level unit may be predetermined to quantitatively present the size of an available space in a data block. The space management structure 400 may be created based on meta information of meta files in a data file group and may include DBA information for each of available space level units of data blocks in the file group. That is, one space management structure 400 may be mapped to a data file group including a plurality of data files.

For example, the available space level unit may be predetermined as four available space level units including 25% (410), 50% (420), 75% (430), and 100% (440), as shown in FIG. 4, and the space management structure 400 may be obtained by arranging DBA of the data blocks in correspondence to the available space level units in accordance with the available spaces of data blocks that are managed by a meta block. The above-described detailed description of the available space level units is only an example and the present invention is not limited thereto.

The processor 130 may create the space management structure 400 for one or more data blocks based on at least one item of information of first information, second information, and third information included in meta information. For example, when first information included in meta information includes information for a meta block to manage a first data block to a thirteenth data block (i.e., thirteen data blocks) and second information includes information presenting that the sizes of the available space of the first data block to the thirteenth data block are respectively 25%, 54%, 60%, 53%, 75%, 25%, 3%, 12%, 18%, 100%, 100%, 100%, and 100%, the processor 130 may create the space management structure 400 shown in FIG. 4. In detail, the processor 130 may create the space management structure 400 by matching a DBA 1 and a DBA 6 in correspondence to the available space of 25% (410) based on meta information, matching a DBA 3 and a DBA 4 in correspondence to the available space of 50% (420), matching a DBA 5 in correspondence to the available space of 75% (430), and matching a DBA 10, a DBA 11, a DBA 12, and a DBA 13 in correspondence to the available space of 100% (440). That is, the processor 130 may create the space management structure 400 based on meta information including information about the space of each of data blocks included in one data file and may maintain the space management structure on the memory 122.

The processor 130 may record a first mark in meta information of meta blocks respectively managing the spaces of one or more data blocks included in the space management structure such that the DBAs of the one or more data blocks are not included in duplicate. In more detail, the space management structure 400 may be formed in correspondence to one data file group and the data file group may include one or more data blocks. That is, the space management structure 400 may include the DBAs of some data blocks of one or more data blocks included in a data file group. For example, when one or more data blocks included in a data file group are one hundred (e.g., a DBA 1 to a DBA 100), the space management structure 400 may may include ten data block DBAs (e.g., the DBA 1 to the DBA 10) that are at least some of the hundred data blocks. In this case, in order to prevent the DBA 1 to the DBA 10, that is, the DBAs of ten data blocks from being included in duplicate later in the space management structure 100, it is possible to record a first mark in the meta information of the meta blocks managing the data blocks corresponding to the DBA 1 to the DBA 10. That is, the first mark recorded in meta information may mean that a specific data block has been already included in the space management structure 400. The above-described detailed numerical values of one or more data blocks included in the data file group and one or more data blocks and included in the space management structure are only examples and the present invention is not limited thereto.

That is, when the processor 130 creates the space management structure 400 through the DBAs of some data blocks of one or more data blocks included in one data file group, it is possible to record the data blocks through a first mark in the meta information managing the data blocks included in the space management structure 400. Accordingly, when the DBA of an additional data block is assigned in the space management structure 400, the processor 130 may check whether data blocks recorded in the meta information are currently included in the space management structure 400 by recognizing the first mark of the data blocks. In other words, the processor 130 may more quickly identify the DBAs of data blocks that may be included in the space management structure 400 through the first mark presenting the state of data blocks recorded in the meta information.

Accordingly, the processor 130 may create the space management structure 400 based on meta files respectively corresponding to one or more data files included in a data file group (i.e., create a space management structure corresponding to one data file group), thereby being able to prevent complexity according to the architecture between a plurality of data files that are spaces for storing data in a DBMS. Further, for the DBA of a data block already included in a space management structure, by recording a first mark in the meta information managing the space of the data block, it is possible to more quickly identify the DBA of the data block through the information (first mark) recorded in the meta information when the DBA of an additional data block is included later in the space management structure.

According to an embodiment of the present invention, the processor 130 may determine a data block to be assigned in correspondence to a space request for a data file by referring to the space management structure 400 maintained on the memory 122 in response to the space request. The space request may include information about a Data Manipulation Language (DML) for data insertion. Further, the space request may be a request for one or more data blocks included in a specific data file group and may include at least one of minimum available space information about each of one or more data blocks, minimum available space information about the sum of the available spaces of one or more data blocks, and the number of data blocks. In more detail, the processor 130 may identify the number and/or the size of data blocks to be returned in correspondence to a space request for a data file. Further, the processor 130 may select data blocks to be returned in correspondence to the number and/or the size of the identified data blocks. That is, the processor 130 may select and return one or more data blocks by referring to the space management structure 400 maintained on the memory in correspondence to a space request for a specific data file group.

For example, referring to FIG. 4, when a space request for a data file is a request for one data block with an available space of 50%, the processor 130 may identify a DBA 2, a DBA 3, and a DBA 4 matched with an available space level unit of 50% (420) in the space management structure 400 and may return at least one DBA of the identified DBA 2, DBA 3, and DBA 4 as the DBA of the data block to be returned in correspondence to the space request.

As another example, when a space request for a data file is a request for one data block with an available space of 75%, the processor 130 may identify a DBA 5 matched with an available space level unit of 75% (430) and may select the identified DBA 5 as the DBA of the data block to be returned in correspondence to the space request.

That is, when receiving a space request to insert data, the processor 130 may return a space (i.e., a data block) corresponding to the request by referring to the space management structure 400 maintained on the memory 122.

In other words, when receiving a space request, the processor 130 may search for and return the DBA of a data block corresponding to the space request by referring to the space management structure 400 maintained on the memory 122 without loading meta information stored in the persistent storage 121. Accordingly, it is possible to provide an effect of improving the speed of searching and accessing available spaces.

Since the processor 130 refers to the space management structure 400 in correspondence to a space request, it may remove at least one data block returned from the space management structure 400 when returning at least one data block. That is, when receiving later a second space request that is another space request after returning a first data block in correspondence to a first space request, the processor 130 may remove the first data block to prevent the first data block from being returned from the space management structure 400.

When the number of the DBAs of data blocks included in the space management structure 400 is equal to or less than the number of the DBAs of predetermined data blocks, the processor 130 may assign an additional data block to the space management structure 400. There are DBAs of one or more data blocks in the space management structure 400 and the processor 130 may return the DBA of one or more data blocks in response to a space request. When the processor 130 returned the DBAs of data blocks in correspondence to a plurality of space requests, the number of the DBAs of data blocks that may be assigned in the space management structure 400 in correspondence to space requests may be decreased. In this case, the processor 130 may assign the DBA of an additional data block to the space management structure 400. In detail, the processor 130 may identify the case when the number of the DBAs of data blocks included in the space management structure 400 is equal to or less than the number of the DBAs of predetermined data blocks, and may additionally record the DBAs of at least one or more data blocks in the space management structure 400 based on the meta information of the meta files that respectively manage the spaces of meta file groups (i.e., a plurality of data files) corresponding to the space management structure 400.

In detail, when the number of the DBAs of data blocks that may be assigned in correspondence to a space request of the DBAs of the data blocks included in the space management structure 400 is equal to or less than the number of the DBAs of predetermined data blocks and there is no DBA of a data block to be additionally recorded in the space management structure 400 based on meta information, the processor 130 may identify the High Water Mark (HWM) of each of data file groups mapped to the space management structure 400. In this case, the data blocks that may be assigned in correspondence to a space request of the DBAs of the data blocks included in the space management structure 400 may be data blocks of which the flags recorded on the memory 122 is not a first state. The space (i.e., data blocks) included in a data file is not all used actually, so the HWM of a data file may be a mark for discriminating a used data block and a data block not used yet. That is, the HWM of a data file may mean the maximum value of a data block that has been included at least one time in the space management structure 400 for the data file. That is, the HWM of a data file may present the maximum value of the DBA of a data block that the data file may currently used, and may present the size of a space assigned to the data file.

The processor 130 may create a first HWM by updating a identified HWM.

In detail, the processor 130 may identify an HWM that is the mark for discriminating a used data block and a data block not used yet, and may create a first HWM updated higher than the HWM. That is, by creating a first HWM by updating an HWM such that a non-used data block included in a data file may be used, more data blocks may be included in the space management structure 400. In detail, the processor 130 may identify a meta block for managing the space between an HWM and a first HWM from the persistent storage 121 and may enable more data blocks to be included in the space management structure 400 based on meta information included in the identified meta block. In this case, data blocks between the HWM and the first HWM may be data blocks that are not used yet (i.e., data blocks that have not been loaded in the space management structure 400). In other words, the processor 130 may update the space management structure 400 by including each DBA of data blocks, which are not used yet, in the space management structure 400 based on the meta information of the meta blocks that manage the data blocks.

That is, when the DBAs of the data blocks included in the space management structure 400 is equal to or less than the number of the DBA of predetermined data blocks (i.e., at the point in time when data blocks to be assigned later in correspondence to additional data requests become insufficient), the processor 130 may include additional data blocks (i.e., the data blocks between an HWM and a first HWM) in the space management structure 400 by creating a first HWM. Accordingly, the processor 130 may determine data blocks to be assigned in correspondence to space requests by referring to the space management structure 400 to which additional data blocks are assigned.

According to an embodiment of the present invention, when receiving work completion information that is information about completion of work on an assigned data block, the processor 130 may update the space management information of the assigned data block. In this case, completion of work may mean the point in time of committing after data of a data block is changed, or the point in time when correction of a data block is finished by a transaction.

In detail, when assigning a specific data block in response to a space request and receiving work completion information for the assigned data block, the processor 130 may update the space management information of the data block based on a DML for the space request. For example, when a space request includes information about a DML about insertion of data of 20 MB, a first data block is assigned in response to the space request, and committing of a transaction for the first data block is identified, the processor 130 may update the space management information of the first data block in correspondence to committing for insertion of the data of 20 MB. In this case, the processor 130 may update fourth information, which includes the size of the available space of a data block of the space management information of the first data block, to correspond to insertion of the data of 20 MB (i.e., update such that the available space of the fourth information decreases by 20 MB). The above-described detailed description of the DML included in a space request is only an example and the present invention is not limited thereto.

According to an embodiment of the present invention, the processor 130 may update the meta information of a meta block based on whether an available space level unit corresponding to the fourth information of a data block changes. In, detail the processor 130 may identify committing of a change of data stored in one or more data blocks. When recognizing committing for a change of data stored in one or more data block, the processor 130 may identify whether an available space level unit corresponding to the fourth information of the data block with committing of a change of data identified changes. In detail, the processor 130 may identify whether an available space level unit corresponding to the fourth information of a data block with committing identified changes, by comparing the available space level unit corresponding to the fourth information presenting the size of the available space of a data block before a change of data is committed and the available space level unit corresponding to the fourth information presenting the available space of the data block after a change of data is committed. Further, when a change of the available space level unit corresponding to the fourth information of the data block with committing identified is identified, the processor 130 may update second information included in the meta information of the meta block managing the data block.

For example, when a first data block is updated to have an available space reduced by 20 MB based on committing by a transaction for data insertion, the fourth information of the first data block decreases by 20 MB in available space, so the available space level unit may be changed from 75% to 50%. In this case, the processor 130 may update the available space level unit of the second information included in the meta information of the first meta block managing the space of the first data block to 50%.

As another example, when a first data block is updated to have an available space increased by 10 MB based on committing by a transaction for data deletion, the fourth information of the first data block increases by 10 MB in available space, but the available space level unit may not be changed from 50% to 50%. In this case, the processor 130 may not update the available space level unit of the second information included in the meta information of the first meta block managing the space of the first data block. In other words, it is possible to update meta information only when the available space level unit of a data block changes in correspondence to committing of a transaction for a change of data. The above-described detailed numerical value for the available space level unit of the data block is only an example and the present invention is not limited thereto.

According to another embodiment of the present invention, the processor 130 may update the meta information of a meta block based on whether an available space level unit corresponding to the fifth information of a data block changes. In, detail, the processor 130 may identify a change of data stored in each of one or more data blocks. When recognizing a change of data stored in one or more data blocks, the processor 130 may identify whether an available space level unit corresponding to the fifth information of the data block with a change of data identified changes. In detail, the processor 130 may identify whether an available space level unit corresponding to the fifth information of a data block with a change of data identified changes, by comparing the available space level unit corresponding to the fifth information presenting the size of the available space of a data block before a change of data and the available space level unit corresponding to the fifth information presenting the available space of the data block after a change of data. Further, when a change of the available space level unit corresponding to the fifth information is identified, the processor 130 may update second information included in the meta information of the meta block managing the data block.

For example, when a change occurs due to insertion of data in the first data block, the fifth information of the first data block decreases by 20 MB in available space, so the available space level unit may change from 75% to 50%. In this case, the processor 130 may update the available space level unit of the second information included in the meta information of the first meta block managing the space of the first data block to 50%.

As another example, when a change occurs due to deletion of data in the first data block, the fifth information of the first data block becomes 10 MB in available space, so the available space level unit may change from 50% to 75%. In this case, the processor 130 may update the available space level unit of the second information included in the meta information of the first meta block managing the space of the first data block to 75%. In other words, it is possible to update meta information only when the available space level unit of a data block changes in correspondence to a change of data. The above-described detailed numerical value for the available space level unit of the data block is only an example and the present invention is not limited thereto.

That is, the processor 130 may update the meta information of the meta block managing the space of a data block based on whether the available space level unit corresponding to the fourth information included in the data block changes or whether the available space level unit corresponding to the fifth information included in the data block changes. In other words, the processor 130 may update the meta information of the meta block managing a space of a data block in correspondence to a change of an available space when a transaction for the data block is rolled back without being committed and a change of an available space including even a change without the transaction committed.

According to an embodiment of the present invention, when work for a data block assigned in correspondence to a space request is finished, the processor 130 may include the data block back into the space management structure. In detail, when receiving work completion information that is information that work on a data block assigned in correspondence to a space request is finished, the processor 130 may remove a first mark for the data block from the meta block managing the space of the data block with the work finished. That is, deleting a first mark for a specific data block from a meta block may mean that work on a data block assigned in response to a space request is finished. In other words, when the first mark of each of data blocks that are managed by meta blocks is removed from meta information, the data blocks may be data block with work finished. That is, when the first mark for a specific data block is removed from meta information, the specific data block may be included later in the space management structure.

That is, when a data block is assigned in response to a space request and work on the assigned data block is finished, the processor 130 may remove the first mark from the meta information of the meta block managing the data block. Accordingly, it is possible to more quickly identify the DBA of the data block through the information (i.e., removal of the first mark) recorded in the meta information when intending to include the DBA of an additional data block to the space management structure 400 later.

According to an embodiment of the present invention, the processor 130 may create a check point for securing conformity of a data file and of a meta file managing the space of the data file. In detail, the processor 130 may create a first check point securing that a data file finishes being reflected to a persistent storage until a first point in time. Further, the processor 130 may create a second check point securing that a meta file finishes being reflected to a persistent storage until a second point in time. Further, the processor 130 may predetermine the second point in time to be the same as or earlier than the first point in time.

That is, the point in time when reflection of a change of a meta block to a persistent storage is secured may be the same as or earlier than the point in time when reflection of an actual change of a data block to the persistent storage is secured, so normal recovery is possible when a problem occurs in a DBMS.

In detail, as space management information due to a change of one or more data blocks included in a data file is updated, when the meta information of the meta block managing the spaces of the one or more data blocks is updated (e.g., when the meta information included in a meta block and the actual space management information of a data block are changed, so the meta information of the meta block is updated), the processor 130 may create a redo log for the change of the data block.

In this situation, when a DBMS requires a recovery process due to abnormal end, the processor 130 may perform recovery work on a meta file by applying a redo log for a data block after a first check point and simultaneously updating the meta information of the meta block managing the data file.

In other words, since the point in time when a redo log starts to be applied to a data file for recovery (i.e., a first point in time that is the check point of a data file) has been predetermined to be later than a second point in time when reflection of a change of a meta file to a persistent storage is secured, even if the DBMS downs due to a failure, it is possible to make sure conformity by applying the redo log to the data file and then checking the data block and the meta block managing the data block. That is, conformity may be secured even without a specific redo log for a meta file.

When there is a need for rolling back the meta block managing a data block due to rolling-back of the data block, it is possible to update the meta information of the meta block based on the space management information of the data block after rolling back the data block. Accordingly, the meta block may not need a specific undo log for rolling-back of data that has not been committed due to an error during updating.

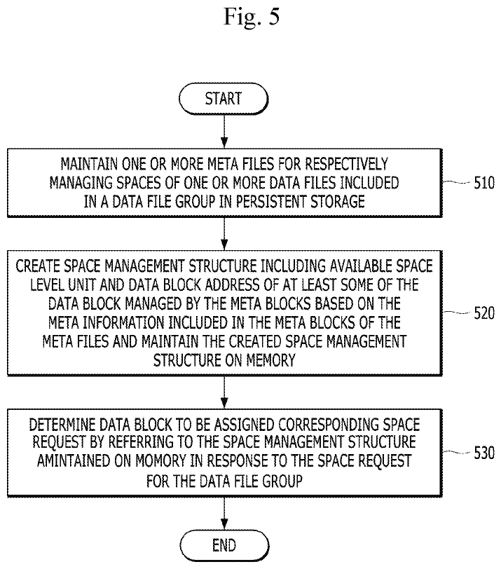

FIG. 5 is a flowchart for providing space management for storing data in a database management system according to an embodiment of the present invention.

The steps shown in FIG. 5 are examples, and an additional step may exist or some of the steps may be omitted.

According to an embodiment of the present invention, the database server 100 may maintain one or more meta files for respectively managing spaces of one or more data files included in a data file group, in a persistent storage (510).

According to an embodiment of the present invention, the database server 100 may create a space management structure including available space level unit and Data Block Address (DBA) of at least some of the data blocks managed by the meta blocks based on the meta information included in the meta blocks of the meta files, and maintain the created space management structure 400 on a memory 122 (520).

According to an embodiment of the present invention, the database server 100 may determine a data blocks to be assigned corresponding to a space request, by referring to the space management structure 400 maintained on the memory 122, in response to the space request for the data file group (530).

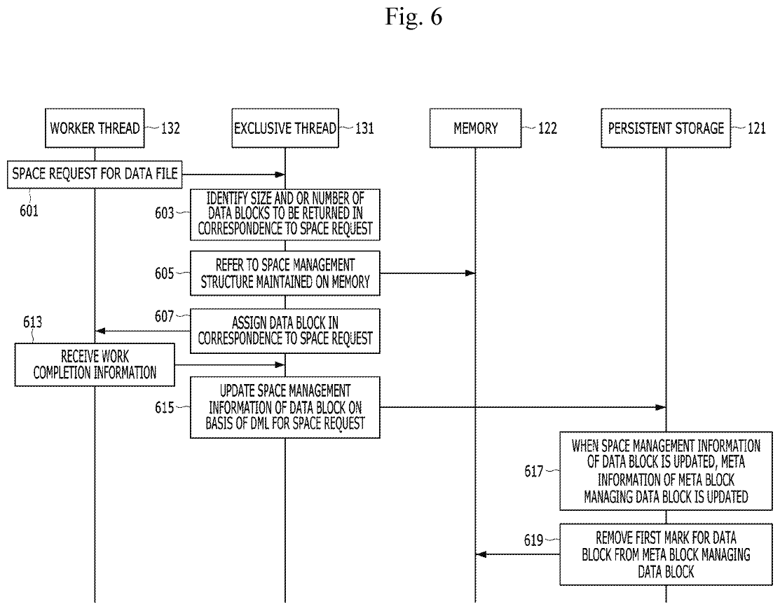

FIG. 6 is a flowchart exemplifying a space management method for storing data in a database management system according to an embodiment of the present invention.

The space management method for storing data in a database management system may be implemented through a plurality of threads. One thread of the plurality of threads may be an exclusive thread and the other threads of the plurality of threads excepting the exclusive thread may be worker threads. That is, a worker thread may mean one or more threads excepting an exclusive thread.

According to an embodiment of the present invention, a worker thread 132 may transmit a space request to an exclusive thread 131 (601). A space request may include information about a DML for data insertion. That is, the worker thread 132 may transmit a space request for requesting a data storage space to the exclusive thread 131 when data needs to be recorded (or inserted).

When receiving a space request from the worker thread 132, the exclusive thread 131 may identify the size and/or number of data blocks to be returned in correspondence to the space request (603). Further, the exclusive thread 131 may refer to the space management structure 400 maintained on the memory 122 to identify data blocks to be returned in correspondence to the space request received from the worker thread 132 (605).

The exclusive thread 131 may assign the DBAs of data blocks to the worker thread that has transmitted the space request by referring to the space management structure 400 maintained on the memory 122 (607). In detail, the exclusive thread 131 may select a data block to be returned in correspondence to the number and/or size of data blocks identified from the space request and assign the data blocks to the worker thread 132 that has transmitted the space request by referring to the space management structure 400.

For example, referring to FIG. 4, when a space request for a data file is a request for one data block with an available space of 50%, the exclusive thread 131 may identify a DBA 2, a DBA 3, and a DBA 4 matched with an available space level unit of 50% in the space management structure 400 and may select at least one DBA of the identified DBA 2, DBA 3, and DBA 4 as the DBA of the data block to be returned in correspondence to the space request.

As another example, when a space request for a data file is a request for one data block with an available space of 75%, the exclusive thread 131 may identify a DBA 5 matched with an available space level unit of 75% (430) and may select the identified DBA 5 as the DBA of the data block to be returned in correspondence to the space request.

That is, when receiving a space request to insert data from the worker thread 132, the exclusive thread 131 may assign a space (i.e., the DBA of a data block) corresponding to the request by referring to the space management structure 400 maintained on the memory 122.

The exclusive thread 131 may receive work completion information from the worker thread 132 (613). When receiving work completion information from the worker thread 132, the exclusive thread 131 may update the space management information of a data block based on the DML for the space request (615). For example, when a space request received from the worker thread 132 is a DML about insertion of data of 20 MB, a first data block is assigned in response to the space request, and work completion information about the first data block is received from the worker thread 132, the exclusive thread 131 may update the space management information of the first data block in correspondence to the DML about insertion of the data of 20 MB. In this case, the exclusive thread 131 may update fourth information, which includes the size of the available space of a data block of the space management information of the first data block, to correspond to insertion of the data of 20 MB (i.e, fourth information decreased by 20 MB in available space). The above-described detailed description of the DML included in a space request is only an example and the present invention is not limited thereto.

When the space management information of the data block is updated, the meta information of the meta block stored in the persistent storage may be updated (617).

When receiving work completion information from the worker thread 132, the exclusive thread 131 may remove a first mark for the data block from the meta block managing the data block (619). In detail, the exclusive thread 131 refers to the space management structure 400 in response to a work request, whereby when the DBA of a data block is assigned, the DBAs of the data blocks included in the space management structure 400 may be data blocks recorded with a first mark in the meta information of the meta files respectively managing the data blocks. Recording a data block with a first mark in meta information may mean that the data block has been already included in the space management structure 400. That is, when work on a data block returned in correspondence to a space request is finished, it is possible to include the data block with work finished back into the space management structure 400 later by removing the first mark of the data block.

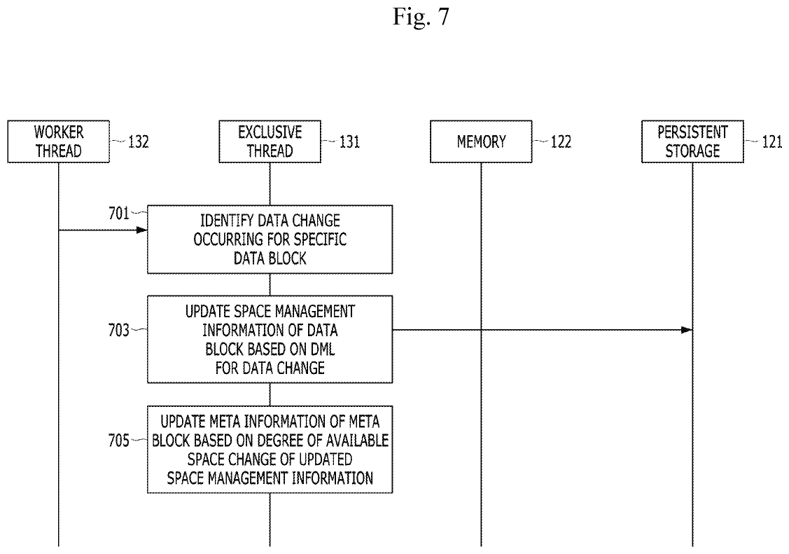

FIG. 7 is a flowchart exemplifying a space management method for storing data in a database management system according to an embodiment of the present invention.

The exclusive thread 131 may identify a data change in the DBMS. A data change may occur when the worker thread 132 performs work completion operation for a DML for deleting and updating of data in a data block. In detail, the exclusive thread 131 may identify whether a data change (e.g., deleting and updating) occurs in a data file that is a data storage space of the DBMS (701).

When the worker thread 132 performs work completion operation of a data change, the exclusive thread 131 may update the space management information of the data block with committing operation of the data change performed (703). For example, when committing operation for a data change in a first data block includes information about a DML for deletion of data of 30 MB, the exclusive thread 131 may update the space management information of the first data block in correspondence to the DML for deletion of data of 30 MB. In this case, the exclusive thread 131 may update fourth information, which includes the size of the available space of a data block of the space management information of the first data block, to correspond to deletion of the data of 30 MB (i.e., update such that fourth information increases by 30 MB in available space). The above-described detailed description of the DML included in a space request is only an example and the present invention is not limited thereto.

The exclusive thread 131 may update meta information of a meta block based on the degree of an available space change of the space management information of a data block (705). In detail, when a data change occurs, it is possible to compare an available space level unit corresponding to fourth information presenting an available space before the data change in a data block and an available space level unit corresponding to fourth information presenting an available space after the data change in a data block. When the available space level unit changes before and after the data change, as the result of comparison, it is possible to update the meta information of a meta block.

For example, when the available space of a data block before a data change is 60% and the available space of the data block after the data change corresponding to a DML for updating of data changes to 30%, whereby an available space level unit changes from 50% to 25%, the meta information of the meta block managing the space of the data block may be updated.

As another example, when the available space of a data block before a data change is 53% and the available space of the data block after the data change corresponding to a DML for deleting of data changes to 83%, whereby an available space level unit changes from 50% to 75%, the meta information of the meta block managing the space of the data block may be updated.

As another example, when the available space of a data block before a data change is 63% and the available space of the data block after the data change corresponding to a DML for updating data changes to 55%, whereby there is no change in an available space level unit (i.e., 50% 50%), the meta information of the meta block managing the space of the data block may be maintained.

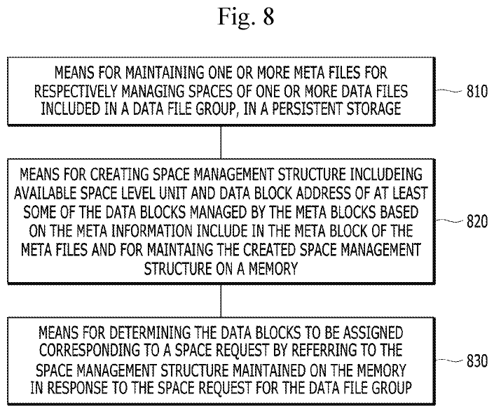

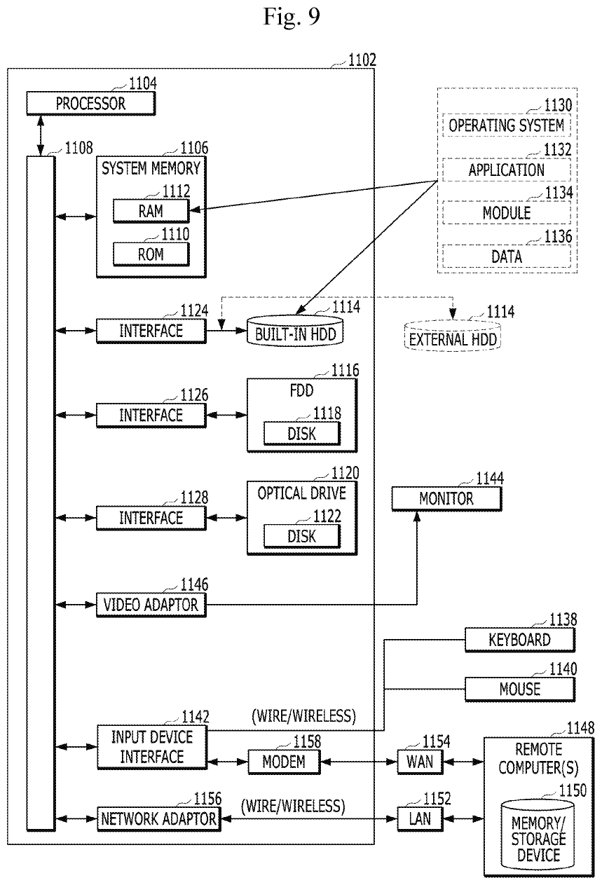

FIG. 8 illustrates means for space management for storing data in a database management system related to an embodiment of the present invention.

According to an embodiment of the present invention, a computer program may be implemented by the following means.

According to an embodiment of the present invention, the computer program may include: a means 810 for maintaining one or more meta files for respectively managing spaces of one or more data files included in a data file group, in a persistent storage, wherein the data file includes one or more data blocks, the meta file includes one or more meta blocks, and the meta block includes meta information for managing the spaces of the one or more data blocks; a means 820 for creating a space management structure including available space level unit and Data Block Address (DBA) of at least some of the data blocks managed by the meta blocks based on the meta information included in the meta blocks of the meta files, and maintaining the created space management structure on a memory, wherein the DBA presents address information of the data block and the available space level unit is predetermined to quantitatively present the size of an available space in the data block; and a means 830 for determining the data blocks to be assigned corresponding to a space request for the data file group, by referring to the space management structure maintained on the memory, in response to the space request.

Alternatively, the number of meta blocks for managing the space of at least some of the data files may be determined based on size information of the data files.

Alternatively, the data file group is mapped to one object, the space management structure corresponds to one data file group, and the object means a logical storage architecture existing in a database and includes at least one of a table and an index.

Alternatively, each of the one or more data blocks includes fourth information presenting the size of an available space to which a change of the available space by uncommitted transaction has not been reflected.

Alternatively, each of the one or more data blocks includes sixth information, which is information about a space variation changed by a data change, when data stored in a data block is changed by a transaction, and the steps further include updating fourth information based on the sixth information when the transaction is committed.

Alternatively, the meta information includes second information presenting the available space level unit of each of one or more data blocks that are managed by the meta blocks, and the available space level unit is based on fourth information presenting the size of an available space to which a change of the available space by uncommitted transaction has not been reflected.

Alternatively, the computer program may further include: a means for identifying a commit of a change of data stored in the one or more data blocks; a means for identifying whether an available space level unit, corresponding to fourth information of the data block that the commit of the change of data is identified, is changed when the commit of the change of data stored in the one or more data blocks is identified; and a means for updating the meta information of the meta block managing the data block when the change of the available space level unit corresponding to the fourth information is identified.

Alternatively, each of the one or more data blocks includes fifth information presenting the size of an actually usable available space to which a change of the available space by uncommitted transaction has been reflected.

Alternatively, the meta information includes second information presenting the available space level unit of each of one or more data blocks that are managed by the meta blocks, and the available space level unit is based on fifth information presenting the size of the available spaces of the data blocks.

Alternatively, the computer program may further include: a means for identifying a change of data stored in the one or more data blocks; a means for identifying whether an available space level unit, corresponding to fifth information of the data block that the change of data is identified, is changed when the change of data stored in the one or more data blocks is identified; and a means for updating the meta information of the meta blocks managing the data block when a change of the available space level unit corresponding to the fifth information is identified.

Alternatively, the meta information includes at least one of: first information presenting the range of one or more data blocks managed by the meta blocks; or third information presenting the number of data blocks corresponding to the available space level unit.

Alternatively, the means 820 for creating a space management structure including available space level unit and Data Block Address (DBA) of at least some of the data blocks managed by the meta blocks based on the meta information included in the meta blocks of the meta files, and maintaining the created space management structure on a memory includes a means for recording a first mark to the meta blocks managing the space of the data blocks corresponding to the DBAs to prevent the data blocks from being included in the space management structure in duplicate, and the computer program may further include a means for receiving work completion information that is information about work completion on a data block assigned corresponding to the space request and a means for removing the first mark for the data block from the meta block managing the space of the data block that work is completed, when the work completion information is received.

Alternatively, the means 820 for creating a space management structure including available space level unit and Data Block Address (DBA) of at least some of the data blocks managed by the meta blocks based on the meta information included in the meta blocks of the meta files, and maintaining the created space management structure on a memory includes a means for additionally assigning the DBA of at least one data block to the space management structure based on the meta information of the one or more meta files corresponding to the space management structure, when it is identified that the number of the DBAs of the data block included in the space management structure is equal to or less than the number of the DBAs of predetermined data blocks.

Alternatively, the means for additionally assigning the DBA of at least one data block to the space management structure based on the meta information of the one or more meta files corresponding to the space management structure, when it is identified that the number of the DBAs of the data block included in the space management structure is equal to or less than the number of the DBAs of predetermined data blocks may include: a means for identifying HWM of a data file mapped to the space management structure, when the DBA of a data block to be additionally assigned to the space management structure does not exist in the meta information of the meta file corresponding to the space management structure; a means for creating a first HWM by updating the identified HWM; and a means for assigning the DBA of an additional data block to the space management structure based on the meta blocks managing the space of the data blocks between the HWM and the first HWM.

Alternatively, the space request includes at least one of: minimum available space information for each of one or more data blocks; minimum available space information for the sum of the available spaces of the one or more data blocks; or information about the number of data blocks.

Alternatively, a means for determining the data blocks to be assigned corresponding to a space request for the data file group, by referring to the space management structure maintained on the memory, in response to the space request may include a means for removing the DBA of at least one returned data block from the space management structure, when at least one data block is returned corresponding to the space request.

Alternatively, the means for determining the data blocks to be assigned corresponding to a space request for the data file group, by referring to the space management structure maintained on the memory, in response to the space request may include: a means for identifying the number and size of data blocks to be returned corresponding to the space request for the data file; and a means for selecting data blocks to be returned corresponding to the identified number and size of data block by referring to the space management structure.

Alternatively, the means for determining the data blocks to be assigned corresponding to a space request for the data file group, by referring to the space management structure maintained on the memory, in response to the space request may include: a means for identifying the size of available space of a data block to be returned in response to the space request for the data file group; and a means for identifying the available space level unit included in the space management structure corresponding to the size of the identified available space, and selecting the DBA of one or more data blocks matched with the identified available space level unit.

According to an embodiment of the present invention, the means for managing spaces for storing data in a database system may be implemented by a module, a circuit, or a logic for implementing a computing device.

Those skilled in the art should note that various exemplary blocks, configurations, modules, circuits, means, logics, and algorithm steps described in association with the embodiments additionally disclosed herein may be implemented by electronic hardware, computer software, or a combination thereof. In order to clearly exemplify compatibility of hardware and software, various exemplary components, blocks, configurations, means, logics, modules, circuits, and steps were generally described above in terms of their functionality. Whether the functionality is implemented by hardware or software depends on specific applications and design limits that are given to the entire system. The functionality described in various methods for specific applications may be implemented by those skilled in the art, but determination of the implementation should not be construed as departing from the range of the invention.

FIG. 9 is a brief and general schematic diagram of an exemplary computing environment in which embodiment of the present invention may be implemented.

The present invention was described above in association with computer-executable commands that may be executed in one or more computers, but it would be apparent to those skilled in the art that the present invention may be implemented by being combined with other program modules and/or by a combination of hardware and software.

In general, a program module includes a routine, a procedure, a program, a component, a data architecture, etc. that perform specific tasks or implement specific types of abstract data. Further, those skilled in the art would know well that the method of the present invention may be achieved by various computer systems including not only a single-processor or multi-processor computer system, a mini computer, a main frame computer, but a personal computer, a handheld computing device, a microprocessor-based or programmable home appliance, etc. (each of which may be connected and operated with one or more relevant devices).

The embodiments of the present invention described above may also be achieved in a distribution computing environment that is performed by remote control devices having tasks connected through a network. In the distribution computing environment, a program module may be disposed in both local and remote memory devices.

A computer generally includes various computer-readable media. A medium that may access a computer may be any computer-readable medium and the computer-readable medium may include a computer-readable storage medium and a computer-readable transmission medium. The computer-readable storage medium includes volatile and nonvolatile media, and portable and non-portable media. The computer-readable storage medium includes volatile and nonvolatile media, and portable and non-portable media that are achieved any method of technology that stores information such as computer-readable commands, data architectures, program modules, or other data. The computer-readable storage medium include a RAM, a ROM, an EEPROM, a flash memory, or other memory technologies, a CD-ROM, a Digital Video Disk (DVD), or other optical disc storage devices, a magnetic cassette, a magnetic tape, a magnetic disc storage device, or other magnetic storage devices, or any other media that may be accessed by a computer and may be used to store desired information, but is not limited thereto.

The computer-readable transmission medium generally includes information transmission media that achieve computer-readable commands, data architectures, program modules, or other data in a modulated data signal, such as a carrier wave or other transport mechanisms. The term ‘modulate data signal’ means a signal of which one or more of characteristics have been set or changed to encode information of the signal. As an example, not a limit, the computer-readable transmission medium includes wired media such as a wired network or a direct-wired connection, and wireless media such as sound, an RF, an infrared ray, and other wireless media. Any combinations of the media are also considered as being included in the range of the computer-readable transmission medium.

An exemplary environment 1100 for implementing several aspects of the present invention including a computer 1102 is shown, and the computer 1102 includes a processor 1104, a system memory 1106, and a system bus 1108. The system bus 1108 connect system components including the system memory 1106 (not limited thereto) to the processor 1104. The processor 1104 may be any processor of various common processors. Dual processor and other multiprocessor architectures may also be used as the processor 1104.

The system bus 1108 may be any one of several types of bus architectures that may be additionally connected to a memory bus, a peripheral device bus, and a local bus using any one of various common bus architectures. The system memory 1106 includes a read only memory (ROM) 110 and a random access memory (RAM) 1112. A basic input/output system (BIOS) is stored in a volatile memory such as a ROM<an EPROM, and an EEROM. The BIOS includes a basic routine that helps transmission of information among components, such as in-operation, in the computer 1102. The RAM 112 may also include a high-speed RAM such as a static RAM for caching data.

The computer 1102 also includes: a built-in Hard Disk Drive (HDD) 1114 (e.g., an EIDE and an SATA), which may also be configured for external use in an appropriate chassis (not shown); a magnetic Floppy Disk Drive (FDD) 1116 (e.g., for being read out from or recorded on a portable diskette 1118); and an optical disk drive 1120 (e.g., for reading out a CD-ROM disc 1122 or being read out from or recorded on a high-capacity optical medium such as a DVD). The HDD 1114, the magnetic disk drive 1116, and the optical FDD 1120 may be connected to the system bus 1108 by a hard disk drive interface 1124, a magnetic disk drive interface 1126, and an optical drive interface 1128, respectively. The interface for implementing an external drive at least one or both of a Universal Serial Bus (USB) and IEEE 1394 interface technology.

The drives and relevant computer-readable media provide nonvolatile storing of data, data architectures, computer-executable commands, and so on. As for the computer 1102, a drive and a medium correspond to storing any data in an appropriate digital format. The description of the computer-readable medium stated above portable optical media such as an HDD, a portable magnetic disk, and a CD or a DVD, but those skilled in the art would know well that other types of computer-readable media such as a zip drive, a magnetic cassette, a flash memory card, and a cartridge may also be used in the exemplary operation environment and these media may include computer-executable commands for performing the methods of the present invention.

Several program modules including the operating system 1130, one or more applications 1132, another program module 1134, and program data 1136 may be stored in the drives and the RAM 1112. All or a portion of the operating system, applications, modules, and/or data may be cached on the RAM 1112. It has been known well that the present invention may be achieved by a various commercially usable operating system or a combination of operating systems.

A user may input instructions and information to the computer 1102 through one or more wire/wireless input device, for example, a pointing device such as a keyboard 1138 and a mouse 1140. As other input devices (not shown), there may be a microphone, an IR remote controller, a joy stick, a game pad, a stylus pen, a touch screen, etc. These input devices and other input devices are usually connected to the processor 1104 through an input device interface connected to the system bus 1108, but may be connected by other interfaces such as a parallel port, an IEEE 1394 series port, a game port, a USB port, and an IR interface.

A monitor 1144 or other types of displays devices are connected to the system bus 1108 through an interface such as a video adaptor 1146. In addition to the monitor 1144, a computer generally includes other peripheral output devices (not shown) such as a speaker and a printer.

The computer 1102 may operate in a networked environment using logical connection to one or more remote computers such as a remote computer(s) 1148 through wire and/or wireless communication. The remote computer(s) 1148 may be a workstation, a server computer, a router, a personal computer, a portable computer, a microprocessor-based game machine, a peer device, or other common network nodes, and generally, includes some or all of the components described in relation to the computer 1102, but only a memory storage 1150 is shown for briefness. The logical connection shown in the figure includes wire/wireless connection to a Local Area Network (LAN) 1152 and/or a larger network, for example, a Wide Area Network (WAN) 1154. Such LAN and WAN networking environments are normal in offices and companies and make an enterprise-wide computer network such as intranet easy, and all of them may be connected to computers all over the world, for example, the internet.

When being used in the LAN networking environment, the computer 1102 is connected to a local network 1152 through a wire and/or wireless communication network interface or the adaptor 1156. The adaptor 1156 may make wire or wireless communication with the LAN 1152 easy and the LAN 1152 includes a wireless access point included therein for communication with the wireless adaptor 1156. When being used in the WAN networking, the computer 1102 may include a modem 1158, or is connected to a communication server on the WAN 1154, or has a means for setting communication through the WAN 1154. The modem 1158 that may be a built-in or external device and a wire or wireless device is connected to the system bus 1108 through the series port interface 1142. In a networked environment, the program modules described in relation to the computer 1102 or some of the program modules may be stored in the remote memory/storage device 1150. The network connection shown in the figure is an example and it would be apparent that other means for setting communication links among computers may be used.

The computer 1102 operates to communicate with any wireless device or object disposed and operated through wireless communication, for example, a printer, a scanner, a desktop and/or portable computer, a Portable Data Assistant (PDA), a communication satellite, any equipment or place related to wireless detectable tags, and a telephone. This includes at least Wi-Fi and Bluetooth wireless technology. Accordingly, communication may be a predefined structure, as in the network of the related art, or may be simply ad hoc communication between at least two devices.

Wi-Fi (Wireless Fidelity) enables connection to the internet even without a line. Wi-Fi is a wireless technology such as a cell phone that, for example, enables a computer to transmit and receive data indoors and outdoors, that is, at any places within the range of a base station. Wi-Fi uses a wireless technology called IEEE 802.11(a,b,g, and so on) to provide safe, reliable, and high-speed wireless connection. Wi-Fi may be used to connect computers to each other, to the internet, and to a wireless network (using IEEE 802.3 or Ethernet). A Wi-Fi network may operate in an unauthorized 2.4 and 5 GHz wireless band, for example, at a data rate of 11 Mbps (802.11a) or 54 Mbps (802.11b), or may operate in a product including both bands (dual band).

Those skilled in the art would understand that various exemplary logic blocks, modules, processors, means, circuits, and algorithm steps described in association with the embodiments disclosed herein may be implemented by electronic hardware, and various types of programs or design codes (which are referred to as “software” herein for the convenience), or a combination of all of them. In order to clearly describe the compatibility of hardware and software, various exemplary components, blocks, modules, circuits, and steps were described above in association with their functions. Whether these functions are implemented by hardware or software depends on specific applications and design limits that are given to the entire system. Those skilled in the art may implement the functions in various ways for specific applications, but the implantation determination should not be construed as departing from the scope of the present invention.

Various embodiments disclosed herein may be implemented as articles using a method, a device, or a standard programming and/or engineering technology. The term “article” includes a computer program, a carrier, or media that may be accessed from any computer-readable devices. For example, the computer-readable medium includes a magnetic storage device (e.g., a hard disk, a floppy disk, and a magnetic strip), an optical disc (for example, a DC and a DVD), a smart card, and a flash memory device (e.g., an EEPROM, a card, a stick, and a key drive), but is not limited thereto. Further, various storage media proposed herein include one or more devices for storing information and/or other machine-readable media. The term “machine-readable media” include wireless channels that may store, keep, and/or transmit an instruction(s) and/or data, and various media, but are not limited thereto.

It should be understood that specific orders or hierarchies of the steps in the proposed processes are examples of exemplary accesses. It should be understood that the specific orders or hierarchies of the steps in the proposed processes may be rearranged within the scope of the present invention based on design priorities. The accompanying method claims provide means of various steps in sample order, but are not limited to the proposed specific order or hierarchy.

The description of the proposed embodiments is provided to enable those skilled in the art to use or achieve the present invention. Various modifications of the embodiments would be apparent to those skilled in the art, and general principles defined herein may be applied to other embodiments without departing from the scope of the present invention. Therefore, the present invention is not limited to the embodiments proposed herein and should be construed in the widest range that is consistent with the principles proposed herein and new characteristics.

What is claimed is:

1. A non-transitory computer readable medium including a computer program, the computer program causing a computer to perform steps for performing space management for data storing of a database management system (DBMS) when executed by one or more processors, the steps including:
maintaining one or more meta files for respectively managing spaces of one or more data files included in a data file group, in a persistent storage, wherein the data file includes one or more data blocks, the meta file includes one or more meta blocks, and the meta block includes meta information for managing the spaces of the one or more data blocks;
creating a space management structure including available space level unit and Data Block Address (DBA) of at least some of the data blocks managed by the meta blocks based on the meta information included in the meta blocks of the meta files, and maintaining the created space management structure on a memory, wherein the DBA presents address information of the data block and the available space level unit is predetermined to quantitatively present the size of an available space in the data block; and
determining the data blocks to be assigned corresponding to a space request for the data file group, by referring to the space management structure maintained on the memory, in response to the space request.

2. The non-transitory computer readable medium of claim 1, wherein the number of meta blocks for managing the space of at least a portion of the data file is determined based on size information of the data files.

3. The non-transitory computer readable medium of claim 1, wherein the data file group is mapped to one object,
the space management structure corresponds to one data file group, and
the object means a logical storage architecture existing in a database and includes at least one of a table and an index.

4. The non-transitory computer readable medium of claim 1, wherein each of the one or more data blocks includes fourth information presenting the size of an available space to which a change of the available space by uncommitted transaction has not been reflected.

5. The non-transitory computer readable medium of claim 4, wherein each of the one or more data blocks includes sixth information, which is information about a space variation changed by a data change, when data stored in a data block is changed by a transaction, and
the steps further include updating fourth information based on the sixth information when the transaction is committed.

6. The non-transitory computer readable medium of claim 1, wherein the meta information includes second information presenting the available space level unit of each of one or more data blocks that are managed by the meta blocks, and
the available space level unit is based on fourth information presenting the size of an available space to which a change of the available space by uncommitted transaction has not been reflected.

7. The non-transitory computer readable medium of claim 6, the steps further include:
identifying a commit of a change of data stored in the one or more data blocks;
when the commit of the change of data stored in the one or more data blocks is identified, identifying whether an available space level unit, corresponding to fourth information of the data block that the commit of the change of data is identified, is changed; and
updating the meta information of the meta block managing the data block when the change of the available space level unit corresponding to the fourth information is identified.

8. The non-transitory computer readable medium of claim 1, wherein each of the one or more data blocks includes fifth information presenting the size of an actually usable available space to which a change of the available space by uncommitted transaction has been reflected.

9. The non-transitory computer readable medium of claim 1, wherein the meta information includes second information presenting the available space level unit of each of one or more data blocks that are managed by the meta blocks, and
the available space level unit is based on fifth information presenting the size of the available spaces of the data blocks.

10. The non-transitory computer readable medium of claim 9, the steps further include:
identifying a change of data stored in the one or more data blocks;
when the change of data stored in the one or more data blocks is identified, identifying whether an available space level unit, corresponding to fifth information of the data block that the change of data is identified, is changed; and
when a change of the available space level unit corresponding to the fifth information is identified, updating the meta information of the meta blocks managing the data block.

11. The non-transitory computer readable medium of claim 1, wherein the meta information includes at least one of:
first information presenting the range of one or more data blocks managed by the meta blocks; or
third information presenting the number of data blocks corresponding to the available space level unit.

12. The non-transitory computer readable medium of claim 1, wherein the creating a space management structure including available space level unit and Data Block Address (DBA) of at least some of the data blocks managed by the meta blocks based on the meta information included in the meta blocks of the meta files, and maintaining the created space management structure on a memory includes:
recording a first mark to the meta blocks managing the space of the data blocks corresponding to the DBAs to prevent the data blocks from being included in the space management structure in duplicate; and
the steps further include:
receiving work completion information that is information about work completion on a data block assigned corresponding to the space request; and
when the work completion information is received, removing the first mark for the data block from the meta block managing the space of the data block that work is completed.

13. The non-transitory computer readable medium of claim 1, wherein creating a space management structure including the DBA and available space level unit of at least some of data blocks managed by the meta blocks based on the meta information included in the meta blocks of the meta file and maintains the created space management structure on the memory, includes:
additionally assigning the DBA of at least one data block to the space management structure based on the meta information of the one or more meta files corresponding to the space management structure, when it is identified that the number of the DBAs of the data block included in the space management structure is equal to or less than the number of the DBAs of predetermined data blocks.

14. The non-transitory computer readable medium of claim 13, wherein additionally assigning the DBA of at least one data block to the space management structure based on the meta information of the one or more meta files corresponding to the space management structure, when it is identified that the number of the DBAs of the data block included in the space management structure is equal to or less than the number of the DBAs of predetermined data blocks includes:
identifying HWM of a data file mapped to the space management structure, when the DBA of a data block to be additionally assigned to the space management structure does not exist in the meta information of the meta files corresponding to the space management structure;
creating a first HWM by updating the identified HWM; and
assigning the DBA of an additional data block to the space management structure based on the meta blocks managing the space of the data blocks between the HWM and the first HWM.

15. The non-transitory computer readable medium of claim 1, wherein the space request includes at least one of:
minimum available space information for each of one or more data blocks;
minimum available space information for the sum of the available spaces of the one or more data blocks; or
information about the number of data blocks.

16. The non-transitory computer readable medium of claim 1, wherein determining the data blocks to be assigned corresponding to a space request for the data file group, by referring to the space management structure maintained on the memory, in response to the space request, includes:
removing the DBA of at least one returned data block from the space management structure, when at least one data block is returned corresponding to the space request.

17. The non-transitory computer readable medium of claim 1, wherein determining the data blocks to be assigned corresponding to a space request for the data file group, by referring to the space management structure maintained on the memory, in response to the space request includes:
identifying the number and size of data blocks to be returned corresponding to the space request for the data file; and
selecting data blocks to be returned corresponding to the identified number and size of data block by referring to the space management structure.

18. The non-transitory computer readable medium of claim 1, wherein determining the data blocks to be assigned corresponding to a space request for the data file group, by referring to the space management structure maintained on the memory, in response to the space request includes:
identifying the size of available space of a data block to be returned in response to the space request for the data file group; and
identifying the available space level unit included in the space management structure corresponding to the size of the identified available space, and selecting the DBA of one or more data blocks matched with the identified available space level unit.

19. A database server for performing space management for data storing of a database management system, the database server comprising:
a processor including one or more cores;
a memory storing program codes that can be executed by the processor; and
a network unit transmitting/receiving data to/from a client,
wherein the processor:
maintains one or more meta files for respectively managing spaces of one or more data files included in a data file group, in a persistent storage, wherein the data file includes one or more data blocks, the meta file includes one or more meta blocks, and the meta block includes meta information for managing the spaces of the one or more data blocks;
creates a space management structure including available space level unit and Data Block Address (DBA) of at least some of the data blocks managed by the meta blocks based on the meta information included in the meta blocks of the meta files, and maintains the created space management structure on a memory, wherein the DBA presents address information of the data block and the available space level unit is predetermined to quantitatively present the size of an available space in the data block; and
determines the data blocks to be assigned corresponding to a space request for the data file group, by referring to the space management structure maintained on the memory, in response to the space request.

20. A method for performing space management for data storing of a database management system, the method comprising:
maintaining one or more meta files for respectively managing spaces of one or more data files included in a data file group, in a persistent storage, wherein the data file includes one or more data blocks, the meta file includes one or more meta blocks, and the meta block includes meta information for managing the spaces of the one or more data blocks;
creating a space management structure including available space level unit and Data Block Address (DBA) of at least some of the data blocks managed by the meta blocks based on the meta information included in the meta blocks of the meta files, and maintaining the created space management structure on a memory, wherein the DBA presents address information of the data block and the available space level unit is predetermined to quantitatively present the size of an available space in the data block; and
determining the data blocks to be assigned corresponding to a space request for the data file group, by referring to the space management structure maintained on the memory, in response to the space request.
